(19) United States
(12) Patent Application Publication
(10) Pub. No.: US 2014/0062363 A1
(43) Pub. Date: Mar. 6, 2014

(54) MOTOR DRIVING APPARATUS

(71) Applicant: SAMSUNG ELECTRO-MECHANICS CO., LTD., Suwon (KR)

(72) Inventor: Joo Yul KO, Suwon (KR)

(73) Assignee: SAMSUNG ELECTRO-MECHANICS CO., LTD., Suwon (KR)

(21) Appl. No.: 13/678,314

(22) Filed: Nov. 15, 2012

(30) Foreign Application Priority Data
Sep. 6, 2012 (KR) 10-2012-0098832

(51) Int. Cl. H02P 6/14

(52) U.S. Cl. CPC H02P 6/14
USPC 318/400.26

(57) ABSTRACT

There is provided a motor driving apparatus capable of implementing a soft switching method using a simple circuit. The motor driving apparatus includes: a driving unit including a plurality of transistor pairs, respectively including at least two transistor units connected between a driving power terminal supplying driving power and a ground, and connected in parallel to each other, the plurality of transistor pairs being switched according to a switching control signal to drive a motor; and a driving control unit providing the switching control signal controlling switching of the respective transistor units of the plurality of transistor pairs, wherein at least one transistor unit of the plurality of transistor pairs includes a plurality of transistors connected in parallel to each other and being switched on or off in a predetermined order.

### CROSS-REFERENCE TO RELATED APPLICATIONS

This application claims the priority of Korean Patent Application No. 10-2012-0098832 filed on Sep. 6, 2012, in the Korean Intellectual Property Office, the disclosure of which is incorporated herein by reference.

### BACKGROUND OF THE INVENTION

1. Field of the Invention

The present invention relates to a motor driving apparatus employing a soft switching method.

2. Description of the Related Art

A brushless direct current (BLDC) motor generally means a DC motor able to conduct a current or adjust a current direction using a non-contact position detector and a semiconductor element rather than using a mechanical contact unit such as a brush, a commutator, or the like, in a DC motor.

In order to drive the BLDC motor, a driving apparatus may be used.

FIG. 1 is a configuration diagram of a general motor driving apparatus.

Referring to FIG. 1, a general motor driving apparatus 10 may include a controlling unit 11 and a driving unit 12.

The controlling unit 11 may control driving of the motor, and the driving unit 12 may drive the motor by turning four field effect transistors (FETs) on or off according to a driving signal of the controlling unit 11.

FIG. 2 is a diagram showing driving signals of the motor driving apparatus.

Referring to FIG. 2, the driving signals transferred from the controlling unit 11 to the driving unit 12 may be divided into four types thereof and may be transferred in a sequence of identification numerals \textcircled{1}, \textcircled{2}, \textcircled{3}, and \textcircled{4}.

That is, a first PMOS FET P1 and a second NMOS FET N2 may be turned on by a driving signal represented by identification numeral \textcircled{1}, and the first PMOS FET P1 and the second NMOS FET N2 may be turned off while a second PMOS FET P2 and a first NMOS FET N1 may be turned on by a driving signal represented by identification numeral \textcircled{2}.

Again, the second PMOS FET P2 and the first NMOS FET N1 may be turned off and the first PMOS FET P1 and the second NMOS FET N2 may be turned on by a driving signal represented by identification numeral \textcircled{3}, and the first PMOS FET P1 and the second NMOS FET N2 may be turned off and the second PMOS FET P2 and the first NMOS FET N1 may be turned on by a driving signal represented by identification numeral \textcircled{4}.

In this driving scheme, when the first PMOS FET P1 and the second PMOS FET P2 are turned on, pulse width modulation (PWM) signals (oblique line portions of FIG. 2) are generated, whereby a speed of the motor may be adjusted.

Such a motor driving apparatus employs a soft switching method of reducing a current surge that occurs during driving of the motor by sequentially increasing or decreasing a duty of a PWM signal to sequentially increase or decrease a current flowing through the motor, as in the invention disclosed in the prior art document below.

However, a circuit structure is complex so as to generate a switching control signal using such a soft switching method, which may increase manufacturing costs and may not allow for a stable operation.

### RELATED ART DOCUMENT

(Patent Document 1) Korean Patent Laid-Open Publication No. 10-1997-0055430

### SUMMARY OF THE INVENTION

An aspect of the present invention provides a motor driving apparatus capable of implementing a soft switching method using a simple circuit.

According to an aspect of the present invention, there is provided a motor driving apparatus including: a driving unit including a plurality of transistor pairs, respectively including at least two transistor units connected between a driving power terminal supplying driving power and a ground, and connected in parallel to each other, the plurality of transistor pairs being switched according to a switching control signal to drive a motor; and a driving control unit providing the switching control signal controlling switching of the respective transistor units of the plurality of transistor pairs, wherein at least one transistor unit of the plurality of transistor pairs includes a plurality of transistors connected in parallel to each other and being switched on or off in a predetermined order.

The plurality of transistors of the at least one transistor unit may have different sizes.

The plurality of transistors of the at least one transistor unit may have the same size.

The driving control unit may provide a plurality of switching control signals that switch on or off the plurality of respective transistors of the at least one transistor unit.

The plurality of switching control signals of the driving control unit may have the same on-duty and off-duty and may be delayed by a predetermined time interval.

According to another aspect of the present invention, there is provided a motor driving apparatus including: a driving unit including a plurality of transistor pairs, respectively including a PMOS transistor unit and an NMOS transistor unit connected between a driving power terminal supplying driving power and a ground, and connected in parallel to each other, the plurality of transistor pairs being switched according to a switching control signal to drive a motor; and a driving control unit providing the switching control signal controlling switching of the respective transistor units of the plurality of transistor pairs, wherein at least one of the PMOS transistor unit and the NMOS transistor unit of the plurality of transistor pairs includes a plurality of transistors connected in parallel to each other and being switched on or off in a predetermined order.

The driving unit may include first and second transistor pairs; the first transistor pair may include a first PMOS transistor unit connected between the driving power terminal supplying driving power and the ground and a first NMOS transistor unit connected between the first PMOS transistor unit and the ground; the second transistor pair may include a second PMOS transistor unit connected between the driving power terminal supplying driving power and the ground and a second NMOS transistor unit connected between the second PMOS transistor unit and the ground; and a connection point of the first PMOS transistor unit and the first NMOS transistor, and a connection point of the second PMOS transistor unit and the second NMOS transistor unit may be respectively connected to a motor.

At least one transistor unit of the first PMOS transistor unit, the first NMOS transistor unit, the second PMOS transistor unit, and the second NMOS transistor unit may include the plurality of transistors having the same polarity, connected in parallel to each other, and being switched on or off in a predetermined order.

The first PMOS transistor unit and the second NMOS transistor unit or the first NMOS transistor unit and the second PMOS transistor unit may respectively include the plurality of transistors having the same polarity, connected in parallel to each other, and being switched on or off in the predetermined order.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a configuration diagram of a general motor driving apparatus;

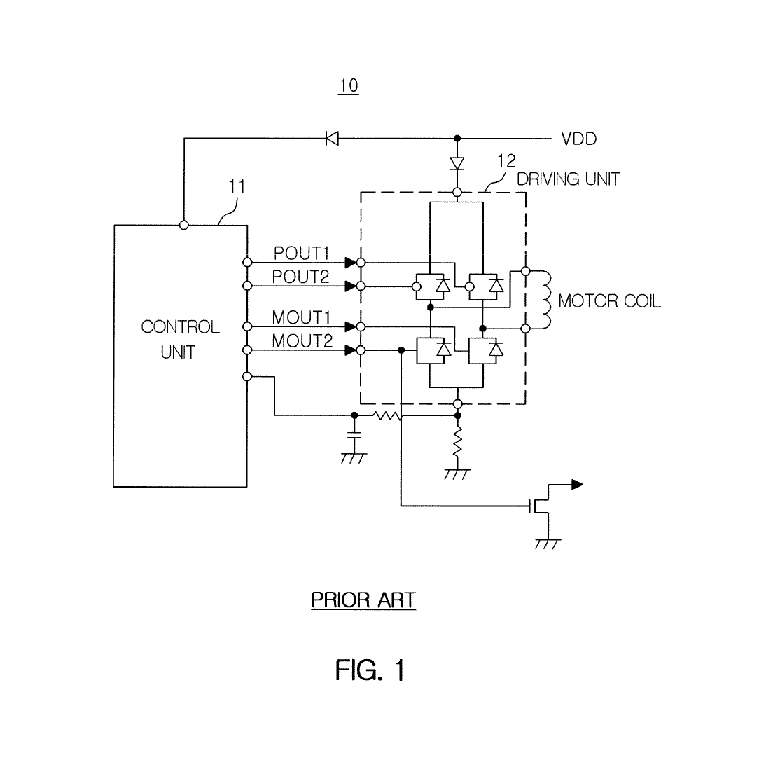

FIG. 2 is a diagram showing driving signals of the motor driving apparatus;

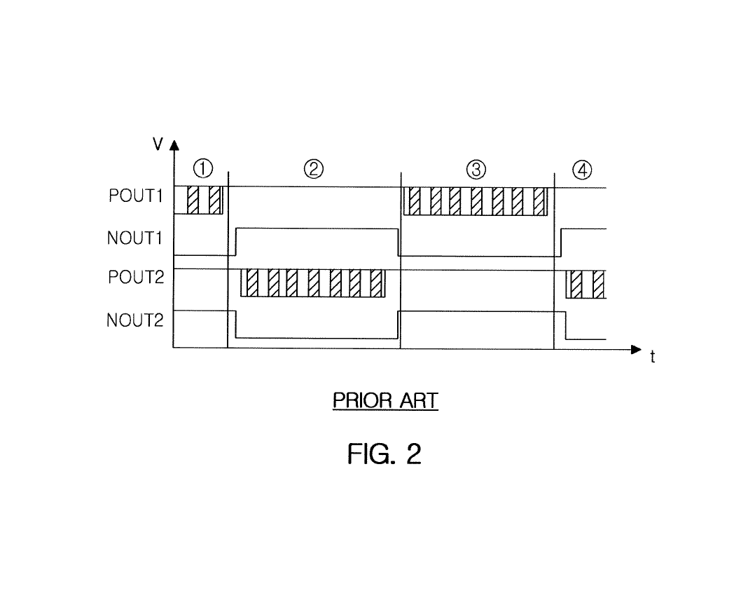

FIG. 3 is a schematic configuration diagram of a motor driving apparatus according to an embodiment of the present invention

FIG. 4 is an expanded view of an NMOS transistor unit employed in the motor driving apparatus according to the embodiment of the present invention;

FIG. 5 is a timing chart of switching control signals used to drive the motor driving apparatus of FIG. 3; and

FIG. 6 is a graph illustrating electrical characteristics according to the switching control signals of FIG. 5.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

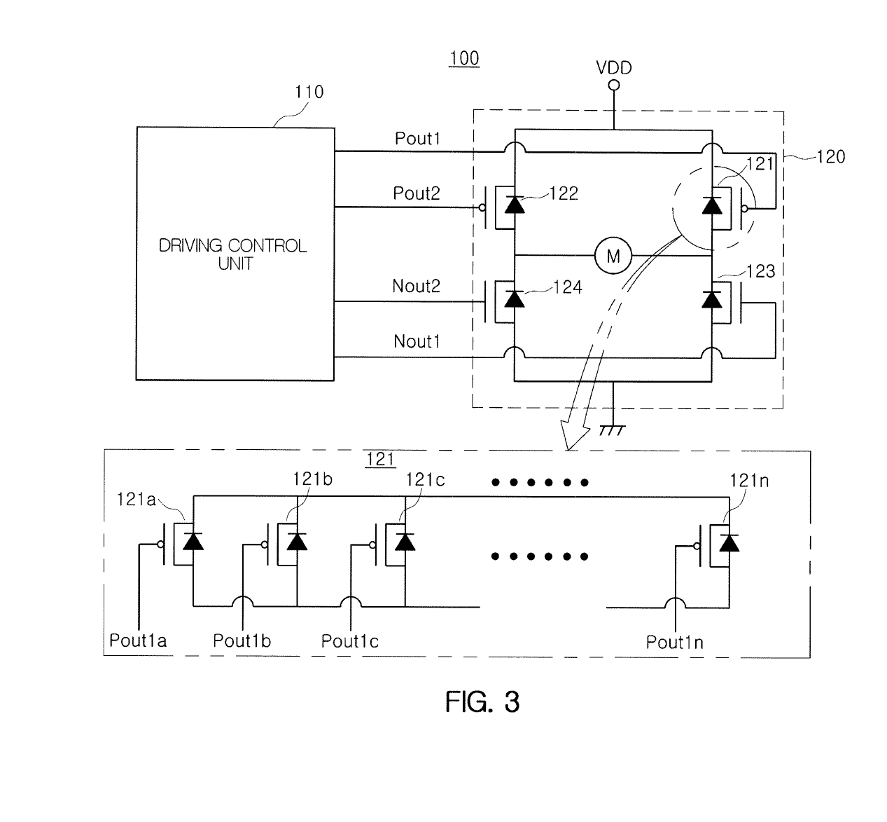

FIG. 3 is a schematic configuration diagram of a motor driving apparatus according to an embodiment of the present invention.

Referring to FIG. 3, the motor driving apparatus 100 may include a driving control unit 110 and a driving unit 120.

The driving control unit 110 may provide switching control signals Pout1, Pout2, Nout1, and Nout2 for controlling driving of the driving unit 120.

The driving unit 120 may include a transistor switched on or off according to a control signal from the driving control unit 110, and a motor may be driven according to switching on or off operation of the transistor.

More specifically, the driving unit 120 may have two transistor pairs, and each of the transistor pairs may include two transistor units. As a result, the driving unit 120 may include a total of four transistor units. The four transistor units may include two p-type metal oxide semiconductor (PMOS) transistor units 121 and 122 and two n-type MOS (NMOS) transistor units 123 and 124.

The PMOS transistor units 121 and 122 may include a first PMOS transistor unit denoted by reference numeral 121 and a second PMOS transistor unit denoted by reference numeral 122, and the NMOS transistor units 123 and 124 may include a first NMOS transistor unit denoted by reference numeral 123 and a second NMOS transistor unit denoted by reference numeral 124. The first PMOS transistor unit 121 may be electrically connected between a power supply terminal for supplying power VDD and a ground. The first NMOS transistor unit 123 may be electrically connected between the first PMOS transistor unit 121 and the ground.

The second PMOS transistor unit 122 may be connected to the power supply terminal in parallel with the first PMOS transistor unit 121 and be electrically connected between the power supply terminal and the ground. The second NMOS transistor unit 124 may be electrically connected between the second PMOS transistor unit 122 and the ground.

In addition, a motor M may be connected to a connection point between the first PMOS transistor unit 121 and the first NMOS transistor unit 123 and a connection point between the second PMOS transistor unit 122 and the second NMOS transistor unit 124, such that the motor M may be driven by switching operations of the first PMOS transistor unit 121 and the second NMOS transistor unit 124, and switching operations of the second PMOS transistor unit 122 and the first NMOS transistor unit 123.

Briefly describing a motor driving operation, the first PMOS transistor unit 121 and the second NMOS transistor unit 124, and the second PMOS transistor unit 122 and the first NMOS transistor unit 123 may be alternatively turned on and off according to the switching control signals Pout1, Pout2, Nout1, and Nout2 from the driving control unit 110.

That is, the first PMOS transistor unit 121 and the second NMOS transistor unit 124 may be turned off and the second PMOS transistor unit 122 and the first NMOS transistor unit 123 may be turned on according to the switching control signals Pout1, Pout2, Nout1, and Nout2 from the driving control unit 110, and the second PMOS transistor unit 122 and the first NMOS transistor unit 123 may be turned off and the first PMOS transistor unit 121 and the second NMOS transistor unit 124 may be turned on according to the switching control signals Pout1, Pout2, Nout1, and Nout2 from the driving control unit 110.

Meanwhile, the switching control signals Pout1, Pout2, Nout1, and Nout2 of the driving control unit 110 may include PWM information. A speed of the motor M may be controlled according to an on- or off-duty of the PWM information.

In this case, a current rapidly flows through the motor M, which may cause a current surge when the motor M is driven. In order to prevent the occurrence of current surge, a soft switching method of sequentially increasing or decreasing a duty of a PWM signal to sequentially increase or decrease a current flowing through a motor may be employed.

However, in order to generate the switching control signal using the soft switching method, a circuit structure may be complex, which increases a manufacturing cost and makes it difficult to perform a stable operation.

In order to solve the defect, in the motor driving apparatus 100 according to the embodiment of the present invention, at least one of the first PMOS transistor unit 121, the first NMOS transistor unit 123, the second PMOS transistor unit 122, and the second NMOS transistor unit 124 of the driving unit 120 may include a structure in which a plurality of transistors are connected in parallel to each other.

The plurality of transistors may have the same polarity as that of the corresponding transistor unit. As shown in FIG. 3, for example, when the first PMOS transistor unit 121 includes a plurality of transistors, the plurality of transistors may include first to n PMOS transistors 121a to 121n.

The first to n PMOS transistors 121a to 121n may receive the switching control signal Pout1 from the driving control unit 110 and may be switched on or off. In this regard, the switching control signal Pout1 of the driving control unit 110 may be a plurality of switching control signals Pout1a to Pout1n that respectively switch the first to n PMOS transistors 121a to 121n on or off.

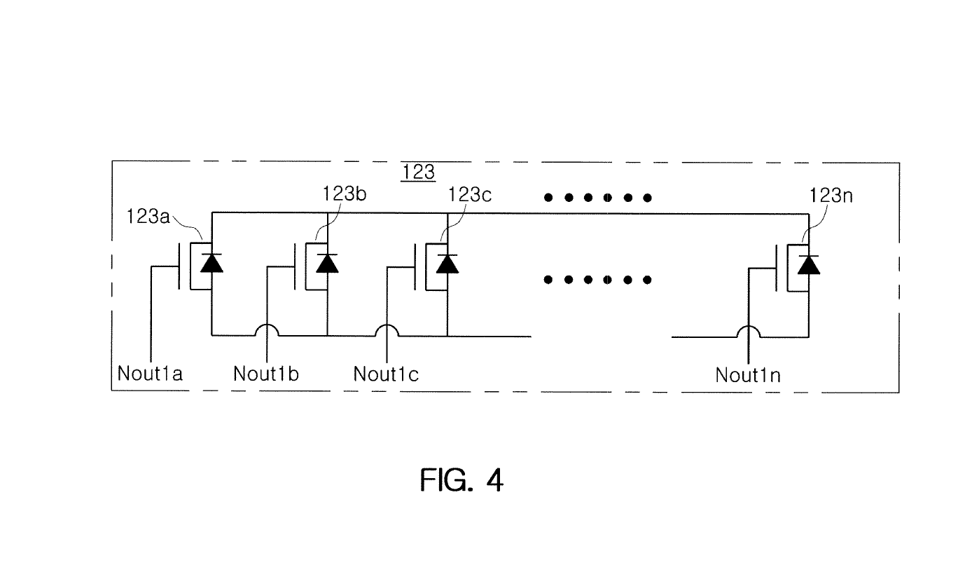

FIG. 4 is an expanded view of an NMOS transistor unit employed in the motor driving apparatus 100 according to the embodiment of the present invention.

Referring to FIGS. 3 and 4, in the motor driving apparatus 100 of the present invention, at least one of the first PMOS transistor unit 121, the first NMOS transistor unit 123, the second PMOS transistor unit 122, and the second NMOS transistor unit 124 of the driving unit 120 may include a structure in a plurality of transistors connected in parallel to each other. The first NMOS transistor unit 123 and the second NMOS transistor unit 124 may respectively include a plurality of transistors, in a similar manner to the case of the first PMOS transistor unit 121 of FIG. 3. For example, the first NMOS transistor unit 123 may include first to n NMOS transistors 123a to 123n.

Likewise, the first to n NMOS transistors 123a to 123n may receive the switching control signal Nout1 from the driving control unit 110 and may be switched on or off. In this regard, the switching control signal Nout1 of the driving control unit 110 may be a plurality of switching control signals Nout1a to Nout1n that respectively switch on or off the first to n NMOS transistors 123a to 123n.

Although not shown, when the motor is driven, the first PMOS transistor unit 121 and the second NMOS transistor unit 124 may be driven together, and the first NMOS transistor unit 123 and the second PMOS transistor unit 122 may be driven together. Thus, each of the first PMOS transistor unit 121 and the second NMOS transistor unit 124 may include the structure in which a plurality of transistors connected in parallel to each other, and each of the first NMOS transistor unit 123 and the second PMOS transistor unit 122 may include the structure in which a plurality of transistors connected in parallel to each other.

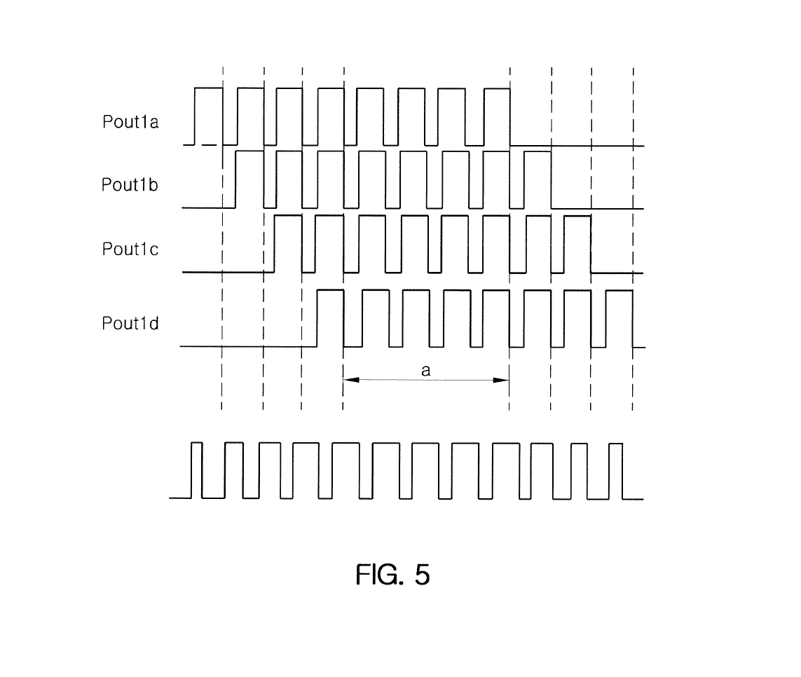

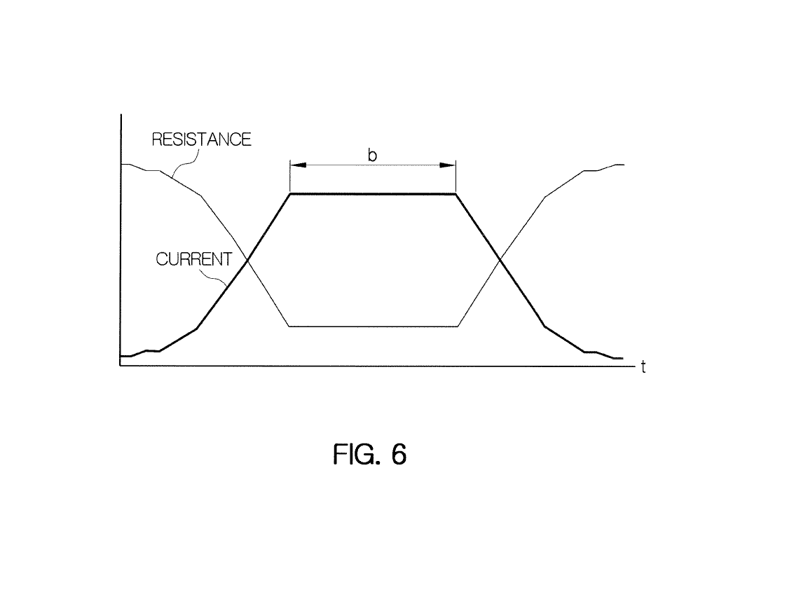

FIG. 5 is a timing chart of switching control signals used to drive the motor driving apparatus 100 of FIG. 3. FIG. 6 is a graph illustrating electrical characteristics according to the switching control signals of FIG. 5.

Referring to FIGS. 3, 4, and 5, the switching control signals used to switch on/off the plurality of transistors of the transistor units 121, 122, 123, and 124 may have the same on-duty and off-duty and may be delayed by a predetermined time interval. That is, a single switching control signal is generated, delayed by the predetermined time interval, and provided to the plurality of transistors, whereby a soft switching method may be implemented using a simple circuit structure.

As shown in FIG. 5, for example, when the first PMOS transistor unit 121 includes first to fourth PMOS transistors 121a, 121b, 121c, and 121d, first to fourth switching control signals Pout1a, Pout1b, Pout1c, and Pout1d respectively used to control the switching of the first to fourth PMOS transistors 121a, 121b, 121c, and 121d may be provided to the driving control unit 110. As shown in FIG. 5, when the first to fourth switching control signals Pout1a, Pout1b, Pout1c, and Pout1d are provided by delaying a single switching control signal by the predetermined time interval, a soft switching method in which the first to fourth PMOS transistors 121a, 121b, 121c, and 121d are sequentially switched on to gradually increase the current flowing through the motor, as shown in FIG. 6; the current flowing through the motor is maintained at the maximum level (reference numeral b) in a section (reference numeral a) where the first to fourth PMOS transistors 121a, 121b, 121c, and 121d are entirely switched on; and thereafter, the first to fourth PMOS transistors 121a, 121b, 121c, and 121d are sequentially switched off to gradually decrease the current flowing to the motor, may be implemented.

As set forth above, according to embodiments of the present invention, a transistor unit for driving a motor, includes a plurality of transistors connected in parallel to each other, and switching control signals used to drive the plurality of transistors have the same duty and are delayed by a uniform interval, whereby a complex circuit may not selected so as to generate a soft switching signal to allow for a reduction in a manufacturing cost and the achievement of a stable operation.

While the present invention has been shown and described in connection with the embodiments, it will be apparent to those skilled in the art that modifications and variations can be made without departing from the spirit and scope of the invention as defined by the appended claims.

What is claimed is:

1. A motor driving apparatus comprising:
a driving unit including a plurality of transistor pairs, respectively including at least two transistor units connected between a driving power terminal supplying driving power and a ground, and connected in parallel to each other, the plurality of transistor pairs being switched according to a switching control signal to drive a motor; and
a driving control unit providing the switching control signal controlling switching of the respective transistor units of the plurality of transistor pairs,
wherein at least one transistor unit of the plurality of transistor pairs includes a plurality of transistors connected in parallel to each other and being switched on or off in a predetermined order.

2. The motor driving apparatus of claim 1, wherein the plurality of transistors of the at least one transistor unit have different sizes.

3. The motor driving apparatus of claim 1, wherein the plurality of transistors of the at least one transistor unit have the same size.

4. The motor driving apparatus of claim 1, wherein the driving control unit provides a plurality of switching control signals that switch on or off the plurality of respective transistors of the at least one transistor unit.

5. The motor driving apparatus of claim 4, wherein the plurality of switching control signals of the driving control unit have the same on-duty and off-duty and are delayed by a predetermined time interval.

6. A motor driving apparatus comprising:
a driving unit including a plurality of transistor pairs, respectively including a PMOS transistor unit and an NMOS transistor unit connected between a driving power terminal supplying driving power and a ground, and connected in parallel to each other, the plurality of transistor pairs being switched according to a switching control signal to drive a motor; and
a driving control unit providing the switching control signal controlling switching of the respective transistor units of the plurality of transistor pairs,
wherein at least one of the PMOS transistor unit and the NMOS transistor unit of the plurality of transistor pairs includes a plurality of transistors connected in parallel to each other and being switched on or off in a predetermined order.

7. The motor driving apparatus of claim 6, wherein the driving unit includes first and second transistor pairs,
the first transistor pair includes a first PMOS transistor unit connected between the driving power terminal supplying driving power and the ground and a first NMOS transistor unit connected between the first PMOS transistor unit and the ground,
the second transistor pair includes a second PMOS transistor unit connected between the driving power terminal supplying driving power and the ground and a second NMOS transistor unit connected between the second PMOS transistor unit and the ground, and
a connection point of the first PMOS transistor unit and the first NMOS transistor, and a connection point of the second PMOS transistor unit and the second NMOS transistor unit are respectively connected to a motor.

8. The motor driving apparatus of claim 7, wherein at least one of the first PMOS transistor unit, the first NMOS transistor unit, the second PMOS transistor unit, and the second NMOS transistor unit includes the plurality of transistors having the same polarity, connected in parallel to each other, and being switched on or off in a predetermined order.

9. The motor driving apparatus of claim 8, wherein the first PMOS transistor unit and the second NMOS transistor unit or the first NMOS transistor unit and the second PMOS transistor unit respectively include the plurality of transistors having the same polarity, connected in parallel to each other, and being switched on or off in the predetermined order.

10. The motor driving apparatus of claim 6, wherein the plurality of transistors of the at least one transistor unit have different sizes.

11. The motor driving apparatus of claim 6, wherein the plurality of transistors of the at least one transistor unit have the same size.

12. The motor driving apparatus of claim 6, wherein the driving control unit provides a plurality of switching control signals that switch on or off the plurality of respective transistors of the at least one transistor unit.

13. The motor driving apparatus of claim 12, wherein the plurality of switching control signals of the driving control unit have the same on-duty and off-duty and are delayed by a predetermined time interval.
